(19) United States
(12) Patent Application Publication
(10) Pub. No.: US 2009/0063770 A1
(43) Pub. Date: Mar. 5, 2009

(54) STORAGE CONTROL APPARATUS, STORAGE CONTROL PROGRAM, AND STORAGE CONTROL METHOD

(75) Inventor: Naoyoshi TOSHINE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/261,340

(22) Filed: Oct. 30, 2008

Related U.S. Application Data
(63) Continuation of application No. PCT/JP2006/310203, filed on May 23, 2006.

(51) Int. Cl. G06F 12/08

(52) U.S. Cl. 711/114; 711/E12.019

(57) ABSTRACT

A storage control apparatus controls a logical volume using a plurality of recording media. The storage control apparatus includes: a management database that manages information of the recording media, type of the logical volume using the recording media, and state of the logical volume, and a control section that sets, when receiving a first instruction of changing a non-mirrored volume set in advance in the management database to a mirrored volume, the non-mirrored volume as a mirrored volume in a non-redundant state which is a state where only one of recording media constituting a mirroring pair exists, in the management database and performs rebuild processing of the mirrored volume in the non-redundant state.

### TECHNICAL FIELD

The present invention relates to a storage control apparatus, a storage control program, and a storage control method for controlling a mirroring configuration.

### BACKGROUND ART

The conventional storage system is mainly a hard disk array apparatus having a large-capacity storage and capable of high-speed access. However, in recent years, as a hierarchical storage system based on the information life cycle management, an apparatus for using a tape library apparatus for virtual use as a part of a hard disk apparatus has been developed. Correspondingly in such a hierarchical storage system, there has been proposed a method of using a plurality of tape media as a logical volume, not as a conventional backup medium.

Although the reliability of a tape drive is comparatively high, there is a possibility that a tape medium is damaged. In recent years, a function referred to as RAIT (Redundant Array of Independent Tapes (also referred to as tape RAIT)) in which a plurality of tape medium are combined to achieve RAID (Redundant Array of Independent Disks) configuration has come to be used in order to prevent data loss due to failure of the tape medium. There are known, for example, as the type of RAIT configuration, RAIT1 in which mirroring is performed and RAIT 5 in which parity bit is recorded, as in the case of the RAID configuration using a hard disk.

As a conventional art related to the present invention, there is known a mirroring apparatus using a magnetic tap apparatus (refer to e.g., Patent Document 1).

Jpn. Pat. Appln. Laid-Open Publication No. 2004-151945

### DISCLOSURE OF THE INVENTION

### Problems to be Solved by the Invention

However, in the conventional RAIT configuration, the setting thereof can be made only at the initial construction time.

Here, RAIT1 volume construction processing of changing non-RAIT volume to a RAIT volume in a conventional storage control apparatus will be described.

FIG. 4 is a flowchart showing an example of operation of the conventional volume construction processing. First a storage control apparatus stops access operation from a host to a target non-RAIT volume (S111). The storage control apparatus then backs up (copies) data of the non-RAIT volume to an unused tape (S112). The storage control apparatus deletes the target non-RAIT volume (S113). The storage control apparatus creates a new RAIT1 volume (S114). Finally, the storage control apparatus restores (copies) the data backed up in step S112 to the RAIT1 volume created in step S113 (S115), and this flow is ended.

In the case where the non-RAIT volume is changed to the RAIT1 volume according to the above procedure, it has conventionally been necessary to prepare a new tape and to stop access operation to the tape until the change is completed.

Next, another conventional RAIT1 volume construction processing will be described.

FIG. 5 is a flowchart showing an example of operation of the conventional RAIT1 volume construction processing. First, when receiving an instruction of changing the non-RAIT volume to the RAIT1 volume (S211), a storage control apparatus assigns the non-RAIT volume as a mirroring source of the RAIT1 volume, as well as assigns unused tape as a mirroring destination of the RAIT1 volume, and correspondingly updates a database for managing a tape library (S212). Then, the storage control apparatus starts data copy processing from the mirroring source to mirroring destination (S213). Then, the storage control apparatus determines whether the data copy processing has been completed (S214).

When determining that the copy processing has not been completed (No in S214), the storage control apparatus returns to S214. On the other hand, when determining that the copy processing has been completed (Yes in S214), the storage control apparatus updates the database such that the RAIT1 volume is set as normal state (S215). Then, the storage control apparatus transmits a completion notification as a reply to the change instruction (S216). Finally, the storage control apparatus performs partial rebuild of differential data written in the copy processing (S217), and this flow is ended.

In the case where the non-RAIT volume is changed to the RAIT1 volume according to the above procedure, it has conventionally been impossible to perform access operation to the tape until the data copy processing from the mirroring source to mirroring destination is completed.

Next, RAIT1 volume cancellation processing of changing RAIT1 volume to non-RAIT volume in a conventional storage control apparatus will be described.

FIG. 6 is a flowchart showing an example of operation of the conventional RAIT1 volume cancellation processing. First, a storage control apparatus stops access operation from a host to a target RAIT1 volume (S311). The storage control apparatus then backs up (copies) data of the target RAIT1 volume (S312). The storage control apparatus deletes the target RAIT1 volume (S313). The storage control apparatus creates a new non-RAIT volume (S314). Finally, the storage control apparatus restores (copies) the data backed up in step S312 to the non-RAIT volume created in step S314 (S315), and this flow is ended.

In the case where the RAIT1 volume is changed to the non-RAIT1 volume according to the above procedure, it has conventionally been necessary to stop access operation to the tape until the change is completed.

The present invention has been made to solve the above problems and an object thereof is to provide a storage control apparatus, a storage control program, and a storage control method capable of changing the mirroring configuration of a storage without need to stop access operation for data copy.

### Means for Solving the Problems

To solve the above problem, according to a first aspect of the present invention, there is provided a storage control apparatus that controls a logical volume using a plurality of recording media, including: a management database that manages information of the recording media, type of the logical volume using the recording media, and state of the logical volume; and a control section that sets, when receiving a first instruction of changing a non-mirrored volume set in advance in the management database to a mirrored volume, the non-mirrored volume as a mirrored volume in a non-redundant state which is a state where only one of recording media constituting a mirroring pair exists, in the management database and performs rebuild processing of the mirrored volume in the non-redundant state.

In the storage control apparatus according to the present invention, when receiving a second instruction of changing a mirrored volume set in advance in the management database to a non-mirrored volume, the control section sets one of recording media constituting a mirroring pair in the mirrored volume as a non-mirrored volume in a normal state in the management database and sets the other one thereof as an unused recording medium in the management database.

In the storage control apparatus according to the present invention, the control section returns a replay to the first instruction immediately after setting the non-redundant state mirrored volume in the management database.

In the storage control apparatus according to the present invention, the control section returns a replay to the second instruction immediately after setting the normal state non-mirrored volume and unused recording medium in the management database.

According to a second aspect of the present invention, there is provided a storage control program that allows a computer to execute control of a storage apparatus having a plurality of recording media, the program allowing the computer to execute: a mirroring construction step that sets, in response to a first instruction of changing a non-mirrored volume set in advance in the storage apparatus to a mirrored volume, the non-mirrored volume as a mirrored volume in a non-redundant state which is a state where only one of recording media constituting a mirroring pair exists; and a rebuild execution step that executes rebuild processing of the non-redundant state mirrored volume set by the mirroring construction step.

The storage control program according to the present invention further allows the computer to execute a mirroring cancellation step that sets, in response to a second instruction changing a mirrored volume set in advance in the storage apparatus to a non-mirrored volume, one of recording media constituting a mirroring pair in the mirrored volume as a non-mirrored volume in a normal state and sets the other one thereof as an unused recording medium.

In the storage control program according to the present invention, the mirroring construction step returns a replay to the first instruction immediately after setting the non-redundant state mirrored volume.

In the storage control program according to the present invention, the mirroring cancellation step returns a replay to the second instruction immediately after setting the normal state non-mirrored volume and unused recording medium.

According to a third aspect of the present invention, there is provided a storage control method that controls a storage apparatus having a plurality of recording media, including: a mirroring construction step that sets, in response to a first instruction of changing a non-mirrored volume set in advance in the storage apparatus to a mirrored volume, the non-mirrored volume as a mirrored volume in a non-redundant state which is a state where only one of recording media constituting a mirroring pair exists; and a rebuild execution step that executes rebuild processing of the non-redundant state mirrored volume set by the mirroring construction step.

### BRIEF DESCRIPTION OF THE DRAWINGS

FIG. 1 is a block diagram showing an example of a configuration of a hierarchical storage system according to an embodiment of the present invention;

FIG. 2 is a flowchart showing an example of operation of RAIT1 volume construction processing according to the present embodiment;

FIG. 3 is a flowchart showing an example of operation of RAIT1 volume cancellation processing according to the present embodiment;

FIG. 4 is a flowchart showing an example of operation of conventional RAIT1 volume construction processing;

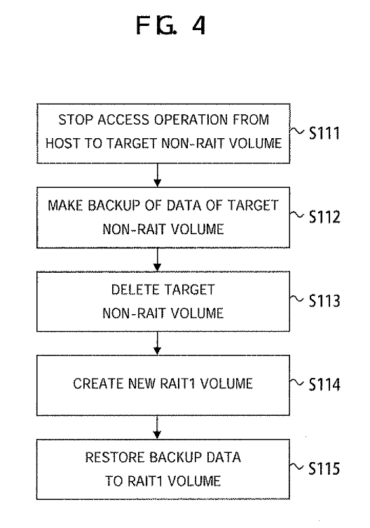

FIG. 5 is a flowchart showing an example of operation of conventional RAIT1 volume construction processing; and

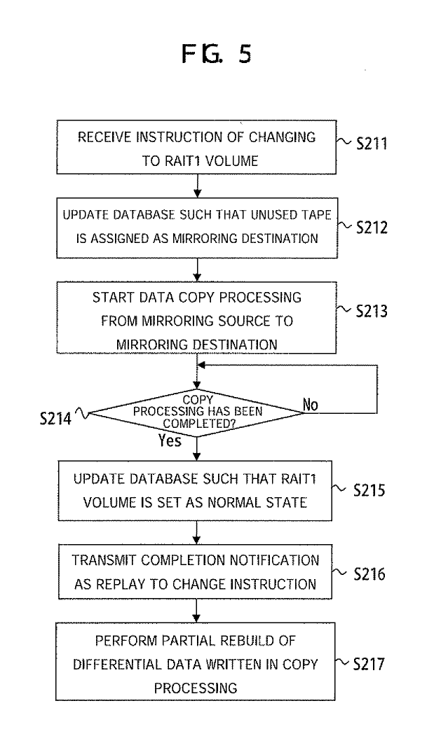

FIG. 6 is a flowchart showing an example of operation of conventional RAIT1 volume cancellation processing.

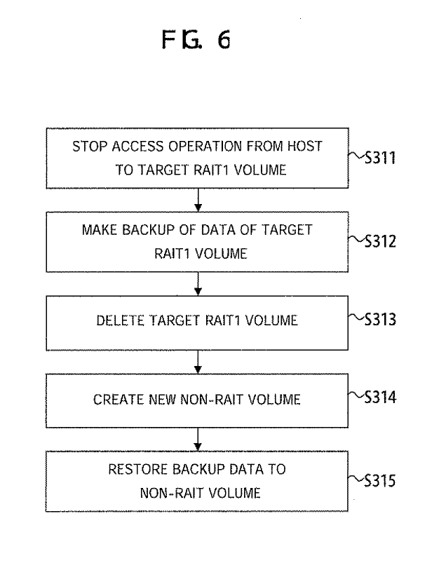

### BEST MODE FOR CARRYING OUT THE INVENTION

Now, an embodiment of the present invention will be described in greater detail by referring to the accompanying drawings.

First, a configuration of a hierarchical storage system having a storage control apparatus according to the present embodiment will be described.

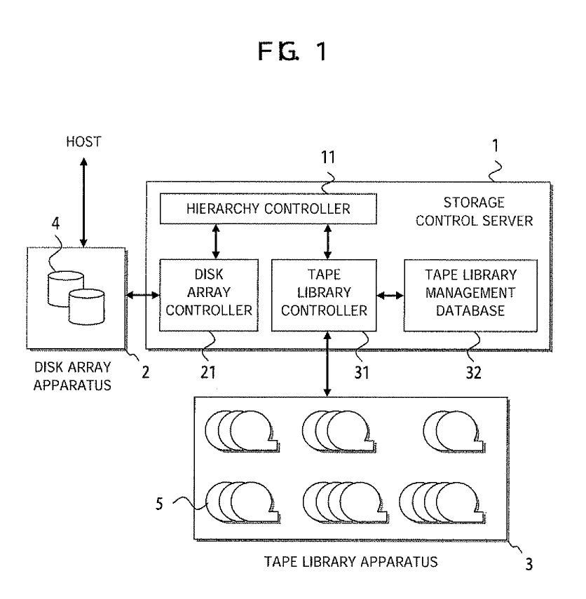

FIG. 1 is a block diagram showing an example of a configuration of a hierarchical storage system according to the present embodiment. The hierarchical storage system shown in FIG. 1 includes a storage control server 1 (storage control apparatus), a disk array apparatus 2, and a tape library apparatus 3. The storage control server 1 includes a hierarchy controller 11, a disk array controller 21, a tape library controller 31 (control section), and a tape library management database 32 (management database).

The tape library management database 32 is a database that manages information of RAIT configuration using the tape library apparatus 3. More specifically, the tape library management database 32 manages information such as tape information (information concerning correspondence with logical volume, information indicating whether the tape is unused one or not, etc.), logical volume type (information indicating whether logical volume is non-RAIT volume or RAIT1 volume), and logical volume state (information indicating whether the logical volume is in a normal state or in a non-redundant state). The tape library controller 31 controls the operation of the tape library apparatus 3 based on the information stored in the tape library management database 32 according to an instruction issued from the hierarchy controller 11.

The disk array apparatus 2 includes a plurality of hard disk media 4 and receives access from a host. The tape library apparatus 3 includes a plurality of tape media 5. The disk array controller 21 controls the operation of the disk array apparatus 2 according to an instruction issued from the hierarchy controller 11. The hierarchy controller 11 performs data migration between the upper level storage or, the disk array apparatus 2 and lower level storage or, the tape library apparatus 3.

RAIT1 volume construction processing of changing non-RAIT volume that is being used by the tape library controller 31 to RAIT1 volume will be described.

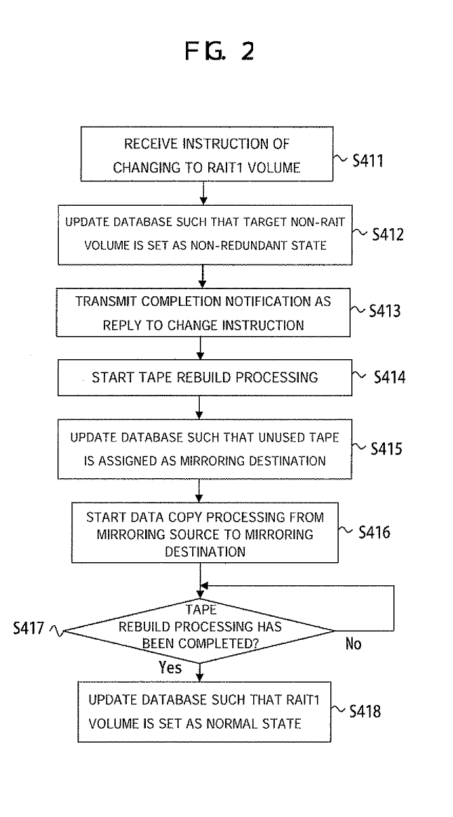

FIG. 2 is a flowchart showing an example of operation of the RAIT1 volume construction processing according to the present embodiment. The tape library controller 31 receives an instruction of changing the non-RAIT volume that is being used by the tape library controller 31 to RAIT1 volume (S411). Then, the tape library controller 31 updates the tape library management database 32 such that the target non-RAIT volume is set as non-redundant state (S412). The non-redundant state means a state where there exists only one of a pair of tapes in the RAIT1 volume, and this state is regarded as abnormal. Then, the tape library controller 31 transmits a completion notification as a reply to the change instruction of S411 (S413).

Then, the tape library controller 31 performs tape rebuild processing (rebuild processing) which is previously-existing data reconstruction processing used for recovery from abnormal time of the RAIT1 volume (S414 to S418). In the rebuild processing, the tape library controller 31 starts the tape rebuild processing (S414). The tape library controller 31 then assigns unused tape as a mirroring destination of the non-redundant state RAIT1 volume and reflects the assignment in the tape library management database 32 (S415). The tape library controller 31 starts data copy processing from the mirroring source to mirroring destination (S416). The tape library controller 31 determines whether the tape rebuild processing has been completed (S417). The tape library controller 31 updates the tape library management database 32 such that the RAIT1 volume is set as normal state (S418), and this flow is ended.

Thus, in the above RAIT1 volume construction processing, the tape library controller 31 only performs update of the tape library management database 32 in response to the change instruction and replies to the change instruction immediately after the update. Further, unlike the conventional way, the tape library controller 31 does not use the data copy. As a result, it is not necessary to stop access operation from a host. Further, the above RAIT1 volume constructing processing can be achieved by using the previously-existing rebuild processing.

RAIT1 volume cancellation processing of changing RAIT1 volume that is being used by the tape library controller 31 to non-RAIT1 volume will be described.

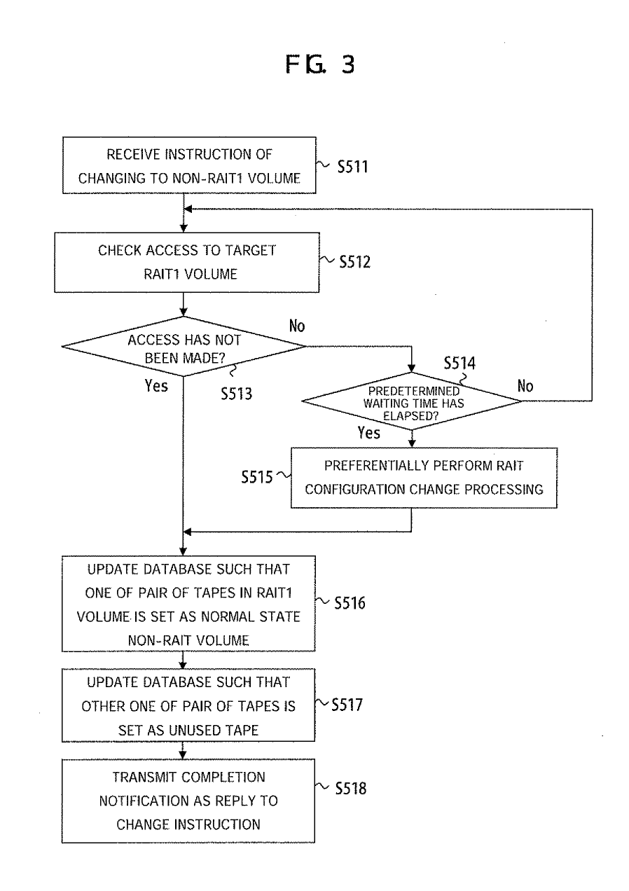

FIG. 3 is a flowchart showing an example of operation of the RAIT1 volume cancellation processing according to the present embodiment. The tape library controller 31 receives an instruction of changing the RAIT1 volume that is being used by the tape library controller 31 to non-RAIT volume (S511). Then, the tape library controller 31 checks access (Recall) from the host to target RAIT1 volume and access (data migration processing) from the disk array apparatus 2 to target RAIT1 volume (S512) to check whether these accesses have been made (S513).

When determining that the access has not been made to the RAIT1 volume (NO in S513), the tape library controller 31 advances to S516. On the other hand, when determining that the access has been made to the RAIT1 volume (Yes in S513), the tape library controller 31 determines whether a predetermined waiting time has elapsed (S514). When determining that a predetermined waiting time has not elapsed (No in S514), the tape library controller 31 returns to S512. On the other hand, when determining that a predetermined waiting time has elapsed (Yes in S514), the tape library controller 31 determines to make subsequent access to the RAIT1 volume to wait and preferentially performs the RAIT configuration change processing (S515) and then advances to S516.

In S516, the tape library controller 31 updates the library management database 32 such that one of a pair of tapes in the RAIT1 volume is changed to a normal state non-RAIT volume (S516) and the other of the pair is changed to an unused tape (S517). The tape library controller 31 then transmits a completion notification as a reply to the change instruction of S511 (S518), and this flow is ended.

Thus, in the above RAIT1 volume cancellation processing, the tape library controller 31 only performs update of the tape library management database 32 in response to the change instruction and replies to the change instruction immediately after the update. Further, unlike the conventional way, the tape library controller 31 does not use the data copy. As a result, it is not necessary to stop access operation from a host.

According to the present embodiment, it is possible to dynamically switch between a reliability-oriented RAIT1 volume and cost-oriented non-RAIT volume without need to stop access operation for data copy, thereby improving convenience for a user. Further, extra unused tapes for data backup are not required at the time of the configuration change, thereby reducing cost associated with the configuration change.

A mirroring construction step corresponds to the processing of S411 to S413 in the embodiment. A rebuild execution step corresponds to the processing of S414 to S418 in the embodiment. A mirroring cancellation step corresponds to the processing of S511 to S518 in the embodiment.

Although the tape medium is used as the lower level storage in the present embodiment, a disk medium such as an optical disk, a magnet-optical disk, or magnet disk may be used as the lower level storage.

The storage control apparatus according to the present embodiment can easily be applied to a storage system or a lower level storage in a hierarchical storage system to thereby further improve performance of the storage system. Examples of the storage system and lower level storage can include a tape library apparatus, a disk library apparatus, and the like.

Further, it is possible to provide a program that allows a computer constituting the storage control apparatus to execute the above steps as a storage control program. By storing the above program in a computer-readable storage medium, it is possible to allow the computer constituting the storage control apparatus to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

### INDUSTRIAL APPLICABILITY

As described above, according to the present invention, it is possible to change the mirroring configuration of a storage without need to stop access operation for data copy.

1. A storage control apparatus that controls a logical volume using a plurality of recording media, comprising:
a management database that manages information of the recording media, type of the logical volume using the recording media, and state of the logical volume, and
a control section that sets, when receiving a first instruction of changing a non-mirrored volume set in advance in the management database to a mirrored volume, the non-mirrored volume as a mirrored volume in a non-redundant state which is a state where only one of recording media constituting a mirroring pair exists, in the management database and performs rebuild processing of the mirrored volume in the non-redundant state.

2. The storage control apparatus according to claim 1, wherein,
when receiving a second instruction of changing a mirrored volume set in advance in the management database to a non-mirrored volume, the control section sets one of recording media constituting a mirroring pair in the mirrored volume as a non-mirrored volume in a normal state in the management database and sets the other one thereof as an unused recording medium in the management database.

3. The storage control apparatus according to claim 1, wherein
the control section returns a replay to the first instruction immediately after setting the non-redundant state mirrored volume in the management database.

4. The storage control apparatus according to claim 2, wherein
the control section returns a replay to the second instruction immediately after setting the normal state non-mirrored volume and unused recording medium in the management database.

5. A storage control program that allows a computer to execute control of a storage apparatus having a plurality of recording media, the program allowing the computer to execute:
a mirroring construction step that sets, in response to a first instruction of changing a non-mirrored volume set in advance in the storage apparatus to a mirrored volume, the non-mirrored volume as a mirrored volume in a non-redundant state which is a state where only one of recording media constituting a mirroring pair exists; and
a rebuild execution step that executes rebuild processing of the non-redundant state mirrored volume set by the mirroring construction step.

6. The storage control program according to claim 5, further allowing the computer to execute a mirroring cancellation step that sets, in response to a second instruction changing a mirrored volume set in advance in the storage apparatus to a non-mirrored volume, one of recording media constituting a mirroring pair in the mirrored volume as a non-mirrored volume in a normal state and sets the other one thereof as an unused recording medium.

7. The storage control program according to claim 5, wherein
the mirroring construction step returns a replay to the first instruction immediately after setting the non-redundant state mirrored volume.

8. The storage control program according to claim 6, wherein
the mirroring cancellation step returns a replay to the second instruction immediately after setting the normal state non-mirrored volume and unused recording medium.

9. A storage control method that controls a storage apparatus having a plurality of recording media, comprising:
a mirroring construction step that sets, in response to a first instruction of changing a non-mirrored volume set in advance in the storage apparatus to a mirrored volume, the non-mirrored volume as a mirrored volume in a non-redundant state which is a state where only one of recording media constituting a mirroring pair exists; and
a rebuild execution step that executes rebuild processing of the non-redundant state mirrored volume set by the mirroring construction step.

10. The storage control method according to claim 9, further allowing a computer to execute a mirroring cancellation step that sets, in response to a second instruction changing a mirrored volume set in advance in the storage apparatus to a non-mirrored volume, one of recording media constituting a mirroring pair in the mirrored volume as a non-mirrored volume in a normal state and sets the other one thereof as an unused recording medium.

11. The storage control method according to claim 9, wherein
the mirroring construction step returns a replay to the first instruction immediately after setting the non-redundant state mirrored volume.

12. The storage control method according to claim 10 wherein
the mirroring cancellation step returns a replay to the second instruction immediately after setting the normal state non-mirrored volume and unused recording medium.
